(19) United States
(12) Patent Application Publication
(10) Pub. No.: US 2005/0044500 A1
(43) Pub. Date: Feb. 24, 2005

(54) Agent display device and agent display method

(76) Inventors: Katsunori Orimoto, Neyagawa-shi (JP); Toshikazu Ohtsuki, Osaka-shi (JP); Akira Uesaki, Takatsuki-shi (JP); Toshiki Hijiri, Hirakata-shi (JP); Yoshiyuki Mochizuki, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/883,771

(22) Filed: Jul. 6, 2004

(30) Foreign Application Priority Data
Jul. 18, 2003 (JP) 2003-276841

(51) Int. Cl. G09G 5/00

(52) U.S. Cl. 715/706; 715/708; 715/709; 715/711; 715/715; 715/768

(57) ABSTRACT

The agent information setting unit (110) transmits agent information to be displayed to the drawing data generation unit (160) while the object data storage unit (170) stores object data necessary for displaying the agent information. The agent importance level setting unit (120) sets an agent importance level of the agent information to be displayed. The display status determination unit (150) determines the transparency level of the agent information to be displayed, based on the agent importance level. The drawing data generation unit (160) generates drawing data for the agent information to be displayed, based on the agent information, the object data, and the transparency level. The agent drawing unit (180) allows a display unit (210) to display the agent information in accordance with the transparency level, based on the generated drawing data.

### BACKGROUND OF THE INVENTION

(1) Field of the Invention

The present invention relates to a display control technique for a communication terminal in a computer environment, and in particular, to a technique for controlling a character agent to be displayed when useful information is provided for a user.

(2) Description of the Related Art

A technique which utilizes a character called “agent” or “assistant” (hereafter referred to as “agent”) to be displayed in providing practical information related to letters, images or objects has been developed with a view to facilitate the user's operations of a communication terminal in a computer environment. The agent is equipped with a function to provide efficiently useful information by appearing on the screen to call the user's attention while the user uses the communication terminal.

The display of the agent has a first and foremost purpose to provide auxiliary information so that it is required that the agent is displayed on the screen without getting in the way of the information that is practical for the user. For example, when the display of the agent partly hides the contents of an application and interrupts the user's operation, the agent becomes an embarrassment for the user. In order to overcome this problem, a technique to display a character in a position which does not hide a window with high priority (see reference to Japanese Laid-Open Patent Publication No. 2002-73322) or a technique to display an agent in a form of an icon outside the window and to present information by use of an image and movements of the agent (see reference to Japanese Laid-Open Patent Publication No. H11-232009) have been suggested.

The prior art of the agent display method, however, is an approach to control a display position with a view to display the agent in a position which does not get in user's way. Such approach presupposes that the size of the agent to be displayed is extremely small compared to the size of the screen or that the communication terminal may display plural windows at the same time such as a personal computer and a work station. In other words, it is preconditioned that the screen is big enough and there is enough free space for displaying the agent on the screen (e.g., outside the window). Therefore, the above problem cannot be solved with the approach as described above in the cases where the screen size is small and where there is not a free space for displaying the information on the entire screen, such as a communication terminal with a small screen, as is the case of a cell phone and a Personal Digital Assistant (PDA), and a display device or a TV monitor used in a car navigation system.

### SUMMARY OF THE INVENTION

An object of the present invention, conceived in view of the above problem, is to provide an agent display device that can display an agent which assists in providing useful information without giving an impression that the information gets in the way of the display of the application.

In order to achieve the above object, the agent display device according to the present invention is an agent display device for displaying a predetermined agent by superimposing the agent on a background, said device comprising: a background display unit operable to display the background; an agent specification unit operable to specify the agent to be displayed; a transparency level determination unit operable to determine a transparency level in displaying the specified agent; and an agent superimposition unit operable to display the agent with the determined transparency level by superimposing the agent on the background.

Thus, the agent is displayed by superimposing the agent on the background according to the determined transparency level. It is therefore possible to display the agent which provides useful information without giving an impression that the agent gets in the way of the background displaying the application.

In order to achieve the above object, the transparency level determination unit of the present agent display device includes: a background importance level determination unit operable to determine a background importance level of the background based on the event; an agent importance level determination unit operable to determine an agent importance level of the agent based on the event; and a transparency level calculation unit operable to calculate the transparency level based on the background importance level and the agent importance level.

Thus, the transparency level of the agent is changed for the display of the agent, based on the importance level of the information provided for the user as well as the importance level of the background. The agent is therefore displayed with high transparency level for the information with relatively low importance. In this way, the agent can be displayed without hiding the contents displayed on the screen at which the user looks. Namely, the agent information is displayed with low transparency level when the information is of high importance. It is therefore possible to display the agent on all occasions with flexibility.

In order to achieve the above object, the transparency level determination unit of the present agent display device further identifies the background as a screen either in text display or in image display, and determines the transparency level based on the identification.

Thus, the agent is displayed after the optimal transparency level of the agent is determined by comparing the importance level of the contents displayed on the background and the importance level of the agent. It is therefore possible to display not only the importance level of the information transmitted by the agent but also the agent according to the user's use status (e.g., writing an e-mail or looking at the shot images) and improve the user friendliness.

In order to achieve the above object, the agent display device of the present invention may further comprise an instruction reception unit operable to receive an instruction from the user, wherein the transparency level determination unit further changes the transparency level based on the instruction received from the user. The transparency level determination unit of the present agent display device may include: an input detection unit operable to detect a key input from a user; and a time measurement unit operable to measure an elapsed time after the detection; and a transparency level change unit operable to change the determined transparency level according to the elapsed time, and the agent superimposition unit displays the agent with the changed transparency level by superimposing the agent on the background.

Thus, the transparency level of the agent can be changed according to the input from the user. It is therefore possible to operate other applications while leaving the agent displayed in opaque as a note, by performing an input operation in order to increase the transparency level. In the case where the input is continuously operated for the application that is being used by the user for displaying the agent, the agent can be removed automatically without any inputs from the user, by increasing the transparency level with time. In this way, the user can use the communication terminal without minding a presence/absence of the agent display.

In order to achieve the above object, the event detection unit of the present display device may further identify a sender of the received e-mail, and the agent importance level determination unit may determine the agent importance level based on the sender. The event detection unit of the present agent display device may further identify a letter string included in a title of the received e-mail, and the agent importance level determination unit may determine the agent importance level based on the letter string included in the title.

Thus, in the case of displaying the agent at the time of receiving an e-mail, the importance level of the agent is determined according to the sender or the title of the e-mail. It is therefore possible for the user to understand immediately the importance of the received e-mail, and judge whether or not the e-mail should be read immediately, according to the importance.

Furthermore, in order to achieve the above object, the present invention can be realized as an agent display method in which the characteristic units of the agent display device are included as steps and as a program that includes these steps. The program can be either stored in a ROM or the like included in the agent display device or distributed via a storage medium such as a CD-ROM and the like or a transmission medium such as a communication network and the like.

Based on what is described above, the agent display device according to the present invention makes an enormous contribution to the enhancement of the convenience of the communication terminal.

The disclosure of Japanese Patent Application No. 2003-276841 filed on Jul. 18, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate specific embodiments of the invention. In the drawings:

FIG. 1 is a block diagram showing the configuration of the agent display device according to the present invention;

FIG. 2 is an external view of the communication terminal according to the present invention;

FIG. 3A shows an example of the agent information according to the embodiments while FIG. 3B shows an example of the screen displayed with the use of an application according to the embodiments;

FIG. 4A shows an example of the agent information with transparency level “0” (opaque) while FIG. 4B shows an example of the agent information with transparency level “50” (half transparent);

FIG. 5 shows a structural example of the agent information;

FIG. 6 shows examples of image data for agent IDs;

FIG. 7 shows examples of image data for action IDs;

FIG. 8 shows examples of image data for speech balloon IDs;

FIGS. 9A˜9D show respectively an example of the display on the screen: FIG. 9A shows an example of the screen display in normal mode; FIG. 9B shows an example of the screen display in agent display mode; FIG. 9C shows an example of the screen display in agent setting mode; and FIG. 9D shows an example of the screen display in agent setting mode, in the case where a transparency level is changed;

FIG. 10 shows an example indicating a relationship between a background importance level and an agent importance level, based on which a transparency level is determined;

FIG. 11 shows an example for explaining the correspondence between an e-mail address and a level of importance;

FIG. 12 shows an example for explaining the correspondence between a keyword and a level of importance;

FIG. 13 is a conceptual diagram showing a transition of the status in GUI display;

FIG. 14 is a flowchart showing the flow of processing to be operated until the agent information is displayed on the screen;

FIG. 15 is a flowchart showing the flow of processing to be operated until the agent information is removed from the screen; and

FIG. 16 shows an example of the correspondence chart presenting a relationship between the background importance level and the agent importance level, and the transparency level, in the case where the display status of the background is taken into account according to the second embodiment.

### DESCRIPTION OF THE PREFERRED EMBODIMENT(S)

The following describes in detail the embodiments according to the present invention with reference to the drawings. It should be noted that the present invention is explained in the following embodiments with reference to the drawings. The present invention, however, is not limited to them.

### First Embodiment

The communication terminal and the function to display the agent, according to the present invention, will be explained before the detailed description of the embodiments for the present invention.

The communication terminal according to the present invention includes a screen for displaying information (e.g., a liquid crystal panel) and has a Graphical User Interface (GUI) environment which enables an exchange of information with the user by means of screen display. The present communication terminal includes a cell phone, a Personal Digital Assistant (PDA), a car navigation system, a digital TV, and the like.

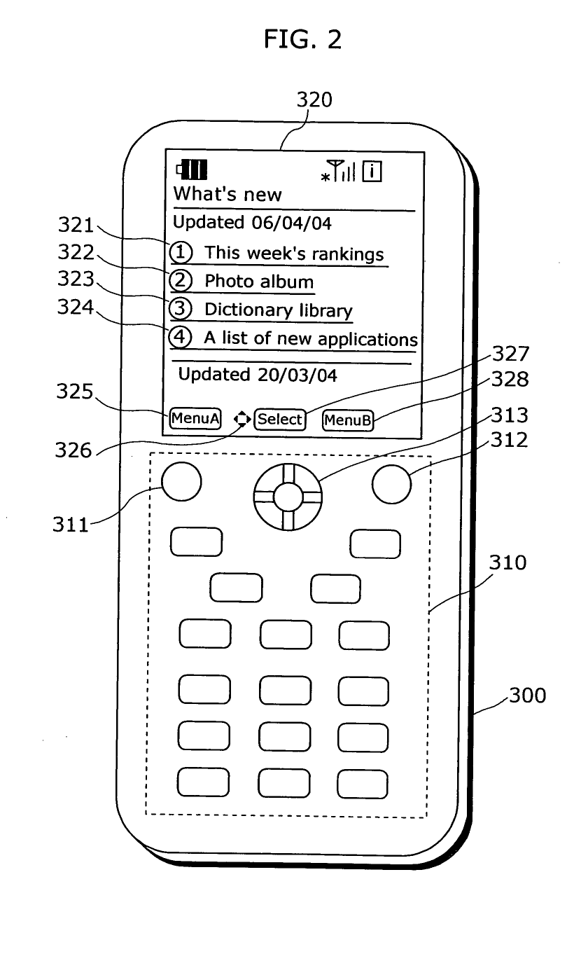

The following gives a brief summary of the operation performed by the communication terminal 300 according to the present embodiment, with reference to the external view of the communication terminal 300 shown in FIG. 2. As shown in FIG. 2, the communication terminal 300 is composed of an input key unit 310 and a display unit 320.

The input key unit 310 made up of plural input keys includes particularly a left menu key unit 311, a right menu key unit 312 and a selection decision key unit 313 which are used for selecting a menu on the screen. The selection decision key unit 313 is a key that enables an input operation when the center or the periphery is pressed (namely, the periphery is pressed in up-and-down or left-and-right directions).

Then, the user interface function of the communication terminal 300 will be explained using an example of the screen shown in the display unit 320. Firstly, a broad classification can be made for the contents shown as examples of the screen: the contents related to a GUI display; and the contents related to an application display.

On one hand, the contents related to the GUI display include a left menu display 325 (button “Menu A”), a direction display 326, a center menu display 327 (button “Select”), and a right menu display 328 (button “Menu B”). The left menu display 325 displays the menu to be operated by pressing the left menu key unit 311 while the right menu display 328 displays the menu to be operated by pressing the right menu key unit 312. The center menu display 327 displays the menu to be operated by pressing the center of the selection decision key unit 313. The direction display 326 displays the directions in which the input can be operated using the selection decision key unit 313.

On the other hand, the contents related to the application display includes “This week's rankings” 321, “Photo album” 322, “Dictionary library” 323 and “A list of new applications” 324. They are the items to be presented by operating each application program, and the user is informed of the selected item by modifying or highlighting the color of the letters. Each of the items is in a selected state in the case where the user presses the selection decision key unit 313 in any direction of up, down, left and right, and the selection of the item is determined when the user presses the center of the selection decision key unit 313.

It should be noted that in the present communication terminal 300, a key input is used as an interface to the user. The present invention, however, is not limited to this, and an input may be operated using a touch panel or voices.

The following describes the agent display function according to the present invention. The present agent display function is a function to display an agent together with useful messages or information for the user who operates the communication terminal 300. The message or information to be provided with the agent may be a message to inform the user of the following: a reception of an e-mail; a reception of an in-coming call; a warning from the system; a schedule set by the user; and a usage of the communication terminal. It should be noted that the information provided together with an agent is referred to as “agent information” in the following.

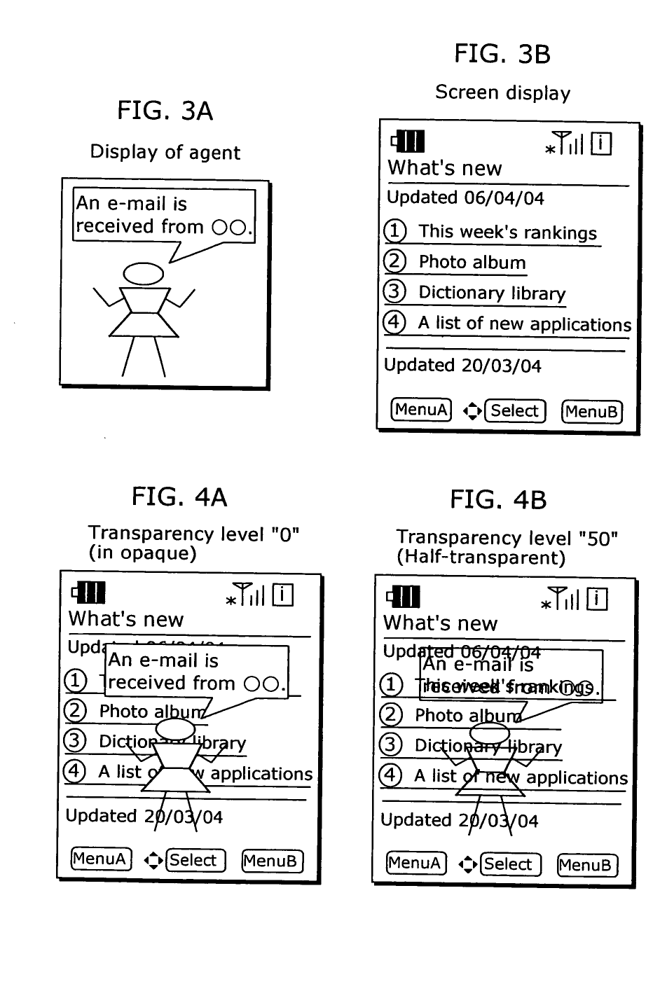

FIG. 3A shows an example of the agent information to be displayed when a message informing that an e-mail is received is provided. The diagram shows how the information indicating the reception of an e-mail is presented together with a humanoid character that appears with movements. The character can surely be a robot or an object such as a board to which a photo is attached, instead of the humanoid one. Thus, by displaying an agent as something familiar to the user or something related to the displayed information, the user can understand easily the presented information.

It should be noted that the agent information presented by the present communication terminal 300 is not limited to the information described above, and other arbitrary information can be surely presented instead.

The following describes a transparency level in displaying the agent information. In general, in the case where the agent is displayed while the user uses the communication terminal 300, an image or text that is already displayed on the screen (hereafter referred to as “background”). The “transparency level” is a degree of the proportion of blending between the background and the agent, in the case where the agent is displayed with the background behind. For example, data format which presents a transparency level can be expressed by an integer ranged from a minimum value “0” and a maximum value “100”. In this case, the transparency level “100” indicates that the display of the agent is completely transparent, which is a state in which the agent cannot be displayed. The transparency level “0” indicates that the display of the agent is completely opaque, which is a state in which the agent is displayed completely on the background.

For example, assume that a screen displayed with the use of the application the user uses is as shown in FIG. 3B. Here, in the case where the agent shown in FIG. 3A is presented in opaque, namely, with the transparency level “0”, the screen is displayed as shown in FIG. 4A. In this case, the part where the agent is displayed hides what is written on the background. In the case where the transparency level is “50”, the display of the background and the agent is blended with same proportion, which gives a state in which the background is visible through the agent.

Here, the processing to blend the background and the agent with the use of the transparency level (hereafter referred to as “blending processing”) will be explained. Firstly, for displaying the agent on the screen, the blending processing is performed for each of the pixels that display the agent. For example, a color value Cx after the blending processing can be obtained using the following equation (1) where a color value of the agent is represented as Ca, a color value of the background is represented as Cb, and a transparency level Ta for the agent is represented within the range of 0˜100.
Cx=(Ca*(100−Ta)+Cb*Ta)/100 (1)

It should be noted that “*” represents a product while the color values Cx, Ca, and Cb are values representing color contrast expressed normally by an integer ranged from “0” to “255” or a float value ranged from “0.0” to “1.0”. In the case where the color value is presented by light's three primary colors such as “Red”, “Green” and “Blue” (i.e., RGB presentation) which are commonly used, the above equation can be used respectively for the colors “Red”, “Green” and “Blue”.

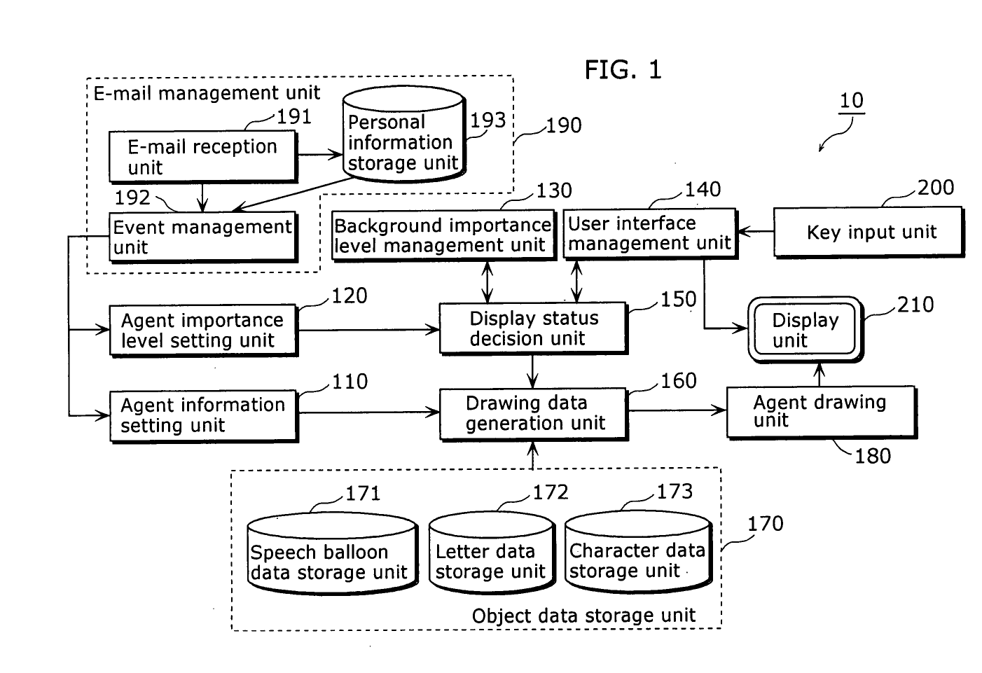

Following the explanation of the communication terminal and the agent display function as well as the transparency level of the agent, according to the present invention as described above, the agent display device 10 according to the present invention will be explained with reference to the drawing. FIG. 1 is a block diagram showing the functional structure of the agent display device 10.

The agent display device 10 is a device for realizing the agent display function of the communication terminal 300, and displays an importance level of the agent information, a user's state of use, and what is more, the agent information to be displayed in an optimal state according to the user's request.

As shown in FIG. 1, the agent display device 10 includes: an agent information setting unit 110; an agent importance level setting unit 120; a background importance level management unit 130; a user interface management unit 140; a display status determination unit 150; a drawing data generation unit 160; an object data storage unit 170; an agent drawing unit 180; an e-mail management unit 190; a key input unit 200; and a display unit 210. The agent display device 10 can be realized with a Central Processing Unit (CPU), a Read-Only Memory (ROM) for storing a control program, data and others, and a Random-Access Memory (RAM) for work, hardware such as a display panel as well as software such as an application program. The exchange of data between each of the hardware is operated via the RAM, a bus, or the like.

The agent information setting unit 110 sets the agent information to be displayed in a predetermined storage area within the drawing data generation unit 160. It should be noted that the agent information setting unit 110 may transmit the agent information to be displayed to the drawing data generation unit 160 via communications. The agent information is made up of an attribute for identifying each element constituting the agent information as well as its attribute value. The attribute value is defined by an integer, a float value or a letter string and its data format differs depending on the attribute.

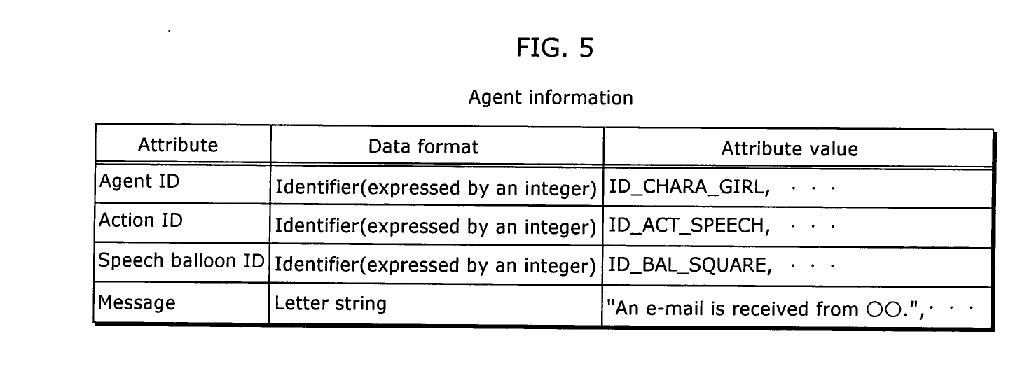

FIG. 5 shows a structural example of the agent information. As shown in FIG. 5, the agent information is made up of an attribute, an attribute value, data format of the attribute value. Here, the attribute value whose data format is “identifier (expressed by an integer)” is registered in advance.

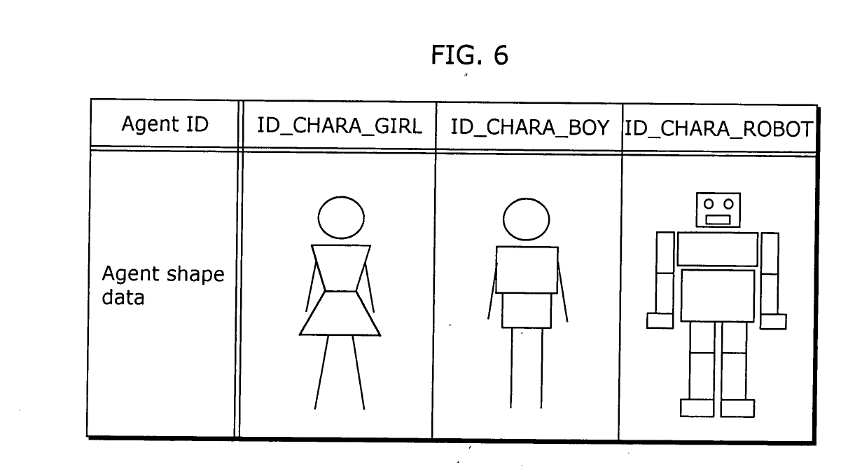

An agent ID, being one of the attributes, is an identifier that represents a type of agents (e.g., an agent created based on a woman and the one created based on a robot). FIG. 6 shows examples of the image data for agent IDs.

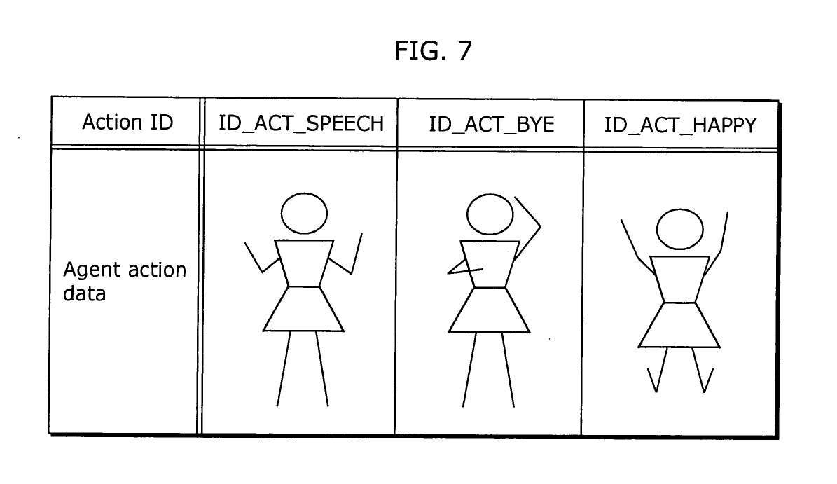

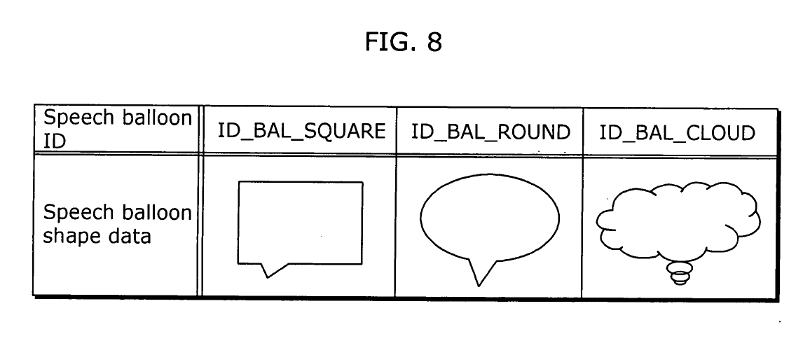

As is described above, the agent ID is to be expressed by an integer that can identify uniquely the image data. In the case where the attribute value of the agent ID is “ID_CHARA_GIRL”, the identifier indicates a female character as shown in FIG. 6. It should be noted that “ID_CHARA_GIRL”, “ID_CHARA_BOY” and “ID_CHARA_ROBOT” shall be respectively expressed by mapping the integers “0”, “1” and “2”. Similarly, examples of the image data for action IDs and speech balloon IDs are respectively shown in FIGS. 7 and 8.

The attribute value of the attribute “message” among the agent information shown in FIG. 5 is expressed in a form of letter string. The attribute value of the letter string may be defined as letter string data for which character codes such as “Unicode” and “SJIS” are used. The letter string data may be stored in the memory so as to specify the following: an identifier indicating the letter string data; an address in the memory; or an address of the bitmap data for defining the letter string data.

It should be noted that in the case where the attribute value is presented by indirect data such as an identifier or a character code, object data indicated in the indirect data shall be stored in the object data storage unit 170. The object data will be explained below in detail in the description of the object data storage unit 170.

The agent importance level setting unit 120 sets a level of importance on the agent information (hereafter referred to as “agent importance level”) determined by the event management unit 192 in a predetermined storage area within the display status decision unit 150. It should be noted that the agent importance level setting unit 120 may transmit the agent importance level to the display status decision unit 150 via communications. For example, the data format for presenting the agent importance level can be expressed by an integer ranged from a minimum value “1” and a maximum value “3”. In this case, the importance of the agent information shall be presented in three levels of “3”, “2” or “1” which respectively indicates “high” “middle” or “low” for the level of importance.

Here, a unit responsible for setting the agent information and the agent importance level is explained. The unit differs depending on the message to be displayed as follows: the e-mail management unit 190 sets the agent information and the agent importance level, as is the case of the present embodiment, in the case of displaying the message related to e-mails; a system management unit (not shown in the diagram) that manages a system, in the case of displaying a message related to a system; and a schedule management unit (not shown in the diagram) that manages a schedule, in the case of displaying a message related to a schedule management. The present embodiment shows the case of displaying the message related to e-mails so that the function of the e-mail management unit 190 is mentioned. Any arbitrary processing unit, however, may set the agent information and the agent importance level.

The background importance level management unit 130 manages the information indicating a level of importance on the contents to be displayed on the background (hereafter referred to as “background importance level”), and outputs the background importance level according to the request from the display status decision unit 150. The following describes in detail the function of the background importance level management unit 130.

The background importance level can be expressed by an integer ranged from the minimum value “1” to the maximum value “3”, as in the case of the agent importance level. For example, the level is set as follows: “1” in the case of an application with low level of importance such as a screensaver; “2” in the case of an application for menu selection since it has a normal level of importance; and “3” in the case of an application of editor for writing e-mails since the background importance is regarded as high. The data stored beforehand in the background importance level management unit 130 may be used for setting the background importance level or the user may set the level.

It should be noted that in the case where one application is used on the screen, only one importance level shall be defined. In the case of using a window system in which plural windows can be displayed such as Windows CE (a registered trademark of Microsoft) and others, the screen is divided into plural windows and plural areas can be specified so that the importance level can be determined for each of the areas. For example, in the case where an application A operates on the right part of the screen while an application B operates on the left part of the screen, respective background importance levels are defined separately for the two areas. In this case, the background importance level management unit 130 receives, from the display status decision unit 150, area information (i.e., information presenting X-Y coordinate for each area) indicating an area to display the agent information, and outputs, to the display status decision unit 150, the background importance level for each of the two areas. The area information in this case can be expressed by sets of coordinate values that can identify the area on the screen. For example, the information for a square area can be expressed by four sets of coordinate values, e.g., (Xa, Ya), (Xb, Yb), (Xc, Yc) and (Xd, Yd). For the case in which the agent information is displayed across plural areas (plural background importance levels exist in this case), any of maximum value, minimum value, and average value can be predetermined to be used as a representative background importance level for the plural importance levels.

The user interface management unit 140 receives, via the key input unit 200, information related to the key inputted from the user. In the case where the key related to the display of the agent information is inputted, the user interface management unit 140 informs the display status decision unit 150 of it. The user interface management unit 140, being also in charge of the management related to the display of GUI on the screen, changes the display of GUI, according to the display status of the agent information, informed by the display status decision unit 150, and outputs, to the display unit 210, the information indicating the GUI thus changed. In the case of the communication terminal 300 shown in FIG. 2, a display (e.g. 325˜328) such as the menus displayed in the lower part of the display unit 320 can be an example of the display of GUI.

It should be noted that a key is inputted, from the key input unit 200, as an input from the user in the present embodiment, however, an input using a touch panel or voices may be accepted instead of the key input. In this case, it is the user interface management unit 140, as in the case of the key input mentioned above, that manages inputs from the user. When an input is related to the display of the agent information, the user interface management unit 140 informs the display status decision unit 150 of it.

The display status decision unit 150 includes a storage area (e.g., RAM) for storing agent importance levels, determines a transparency level indicating the display status of the agent information, and outputs it to the drawing data generation unit 160. It should be noted that the display status decision unit 150 may obtain the agent importance level via communications with the agent importance level setting unit 120.

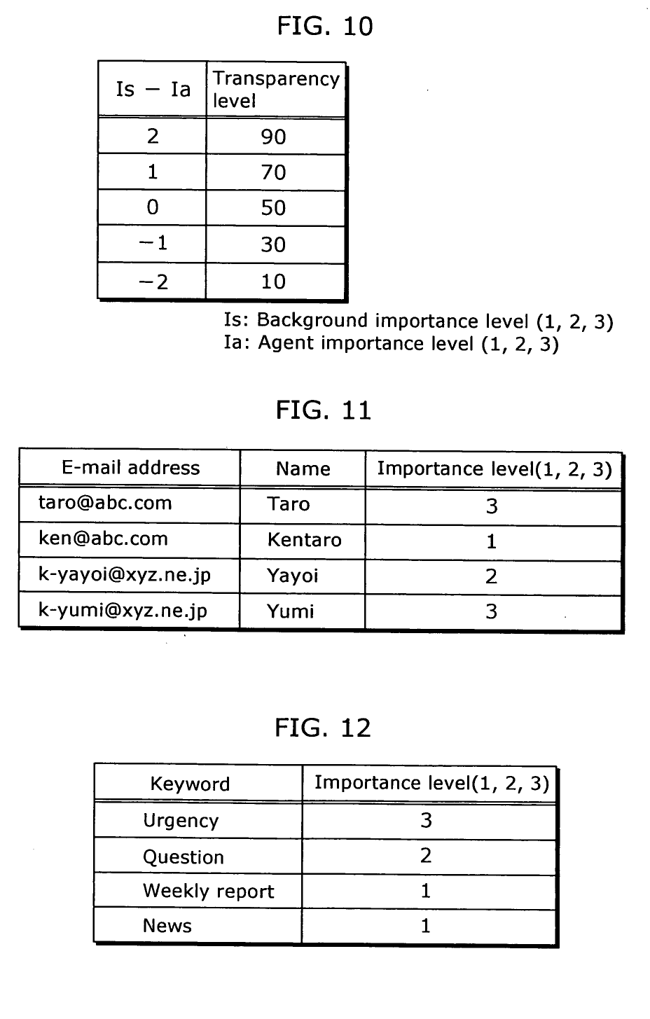

The display status decision unit 150 determines the transparency level of the agent information based on the agent importance level “Ia” that is read out from the predetermined storage area (or an agent importance level obtained via communications with the agent importance level setting unit 120) and the background importance level “Is” that is received from the background importance level management unit 130, and outputs the determined transparency level to the drawing data generation unit 160. An example of the correspondence chart for determining a transparency level is shown in FIG. 10.

FIG. 10 is the correspondence chart indicating the correlation between a difference between the agent importance level “Ia” and the background importance level “Is” (Is-Ia), and the transparency level. Looking closely at the relationship between the “Is-Ia” and the “transparency level”, the transparency level of the agent information is high in the case where the importance level of the screen is high while the importance level of the agent information is low. In the case where the transparency level is high, the agent information is displayed with light tone so that the contents of the application are displayed with priority on the screen. In the case where the transparency level is low, the agent information is displayed with dark tone so that it is displayed with more stress than the contents of the application on the screen.

The display status decision unit 150, having received the instruction to change the transparency level from the user via the user interface management unit 140, further changes the transparency level of the agent information based on the instruction. For example, in the state where the agent information with the transparency level “50” is displayed and when the user instructs to change the transparency level to “90” (i.e. the agent information is displayed with light tone), or to “0” (i.e. the agent is displayed in opaque), the display status decision unit 150 changes the transparency level based on the instruction. The method of changing the transparency level will be explained in detail later.

The drawing data generation unit 160 which includes a predetermined storage area (e.g., RAM) generates drawing data for drawing agent information based on the following: the agent information to be displayed which is set by the agent information setting unit 110 and is read out from the storage area; and the transparency level of the agent information, which is received from the display status decision unit 150. The drawing data generation unit 160 then outputs the generated data to the agent drawing unit 180. An example of the drawing data includes three-dimensional CG data.

The three-dimensional CG data represents a three-dimensional format as a collection of polygons. Each of the polygons can be represented using coordinate values in three-dimensional space. Also, the three-dimensional CG data also includes: material data made up of attributes, each deciding a color value for displaying the polygon; and texture data for attaching bitmap data on the polygon. Such data is generally used in the field of three-dimensional CG.

The object data storage unit 170 stores the object data to be used by the drawing data generation unit 160, and includes a speech balloon data storage unit 171, a letter data storage unit 172 and a character data storage unit 173.

The speech balloon data storage unit 171 stores the speech balloon data which defines the form and color of the speech balloon. FIG. 8 shows examples of the speech balloon data. The speech balloon data is defined by the bitmap data associated with the speech balloon ID that can identify the speech balloon. The bitmap data is a data sequence in which a value representing a color value is defined for each pixel. It should be noted that the speech balloon data may be the three-dimensional CG data in which the speech balloon is represented based on polygon data.

The letter data storage unit 172 stores the letter data necessary for depicting on the screen the data for the letter string included in the agent information. The bitmap data that represents letters or the vector data that defines the outline of the letters can be an example of the letter data, but the type of data should not be particularly restricted to them. Any type of data can be used as far as it is commonly used for displaying letters. More specifically, font data necessary for depicting the letter string “You received an e-mail from ◯◯” on the screen may be used in the case of displaying the agent information, as shown in FIG. 5. The letter data may be the three-dimensional CG data for displaying the letters three-dimensionally.

The character data storage unit 173 stores character data necessary for depicting the character to be displayed together with the information. The following can be given as an example of the character data for expressing three-dimensionally the character as shown in FIG. 6: the three-dimensional CG data such as the polygon data that represents the format of the character; the material data in which the color and material of the polygon are defined; the bitmap data for performing a texture mapping in order to attach a two-dimensional image on the polygon; and the animation data that defines the action of the character, as shown in FIG. 7. The animation data used for the three-dimensional CG data enables animation by defining a format in linkage with a frame having a hierarchical structure and by transforming the coordinates of the nodes forming the frame. The coordinate transformation mentioned above can be represented by defining, in accordance with time, the parameters related to scaling, rotation, and translation of x-axis, y-axis or z-axis. The three-dimensional CG data mentioned above is commonly used in the PC.

The agent drawing unit 180 generates data for display use by executing drawing processing with the use of the drawing data inputted from the drawing data generation unit 160, and outputs the generated data to the display unit 210. In the case where the agent drawing unit 180 uses three-dimensional CG data, the agent drawing unit 180 is made up of hardware for drawing called “graphics accelerator” and software performing the same processing as performed by the graphics accelerator. The graphics accelerator generates color values for the screen based on the coordinate data defined in the three-dimensional space, or the like. Such hardware and software is generally used in the field of three-dimensional CG.

The e-mail management unit 190 manages a reception of an e-mail, and requests the display status decision unit 150, via the agent importance level setting unit 120, to display the agent information indicating that an e-mail is received, by setting the agent information and the agent importance level respectively in the agent information setting unit 110 and the agent importance level setting unit 120.

The e-mail management unit 190 includes an e-mail reception unit 191, an event management unit 192, and a personal information storage unit 193.

The e-mail reception unit 191, having detected the reception of an e-mail, stores the received e-mail in correspondence with an identifier that can uniquely identify the e-mail (e.g., a serial number), and outputs, to the event management unit 192, the identifier of the received e-mail.

The event management unit 192 obtains, from the personal information storage unit 193, the information related to the e-mail that corresponds to the identifier of the e-mail received from the e-mail reception unit 191, and determines the agent importance level based on the information on the e-mail. For example, sender, title, date of reception, date of transmission and destination, of the e-mail, are included in the information.

Here, two methods for determining an agent importance level, performed by the event management unit 192, will be mentioned.

The first method is to determine an agent importance level based on a sender of the e-mail. It is assumed that information (e.g., correspondence chart) indicating a correspondence between an e-mail address and an agent importance level, as shown in FIG. 11, is stored in the personal information storage unit 193. The communication terminal 300 such as a cell phone, in general, has an application for managing personal information such as names and telephone numbers, and can set an e-mail address in association with the name (letter string) set by the user. The agent importance level, as in the case of the e-mail address, is set by the user according to the sender of the e-mail. It should be noted that for the sender of the e-mail whose importance level is not set by the user, an importance level that is fixed beforehand (e.g., “2” indicating a normal level of importance) shall be used. Thus, the event management unit 192 determines the agent importance level corresponding to the e-mail address of the sender of the received e-mail, by referring to the correspondence chart stored in the personal information storage unit 193.

The second method is to determine an agent importance level based on the letter string included in the title of the e-mail. It is assumed that the information (e.g., correspondence chart) indicating a correspondence between a keyword and an agent importance level, as shown in FIG. 12, is stored in the personal information storage unit 193. It should be noted that the information indicating the correspondence (e.g., correspondence chart) may be set or changed according to the user's instruction. The event management unit 192 examines whether or not any one of the keywords is included in the letter string of the title of the received e-mail. In the case where such keyword is included, the event management unit 192 obtains the agent importance level that corresponds to the keyword. It should be noted that in the case where even one keyword is not included at all, the importance level that is fixed beforehand (e.g., “2” indicating a normal level of importance) shall be used.

The personal information storage unit 193 is a storage apparatus for storing personal information, e.g. name, e-mail address, and telephone number, and is composed of a non-volatile memory that is rewritable such as a flash memory or an external memory such as an SD card.

The key input unit 200 receives the key input from the user and outputs it to the user interface management unit 140. The key input unit 200 is an equivalent of the input key unit 310 in the communication terminal 300.

The display unit 210 is hardware for displaying information (image, text, etc) for the user, and for example, a display device such as a CRT, a liquid crystal display, an organic EL display is the equivalent. The display unit 210 is an equivalent of the display unit 320 in the communication terminal 300.

The following describes the operations performed by the agent display device 10 constructed as described above. The operations can be classified broadly into two-types: processing to be operated until the agent information is displayed on the screen (hereafter to be referred to as “processing (1)”); and processing to be operated until the displayed agent information is removed from the screen (hereafter to be referred to as “processing (2)”).

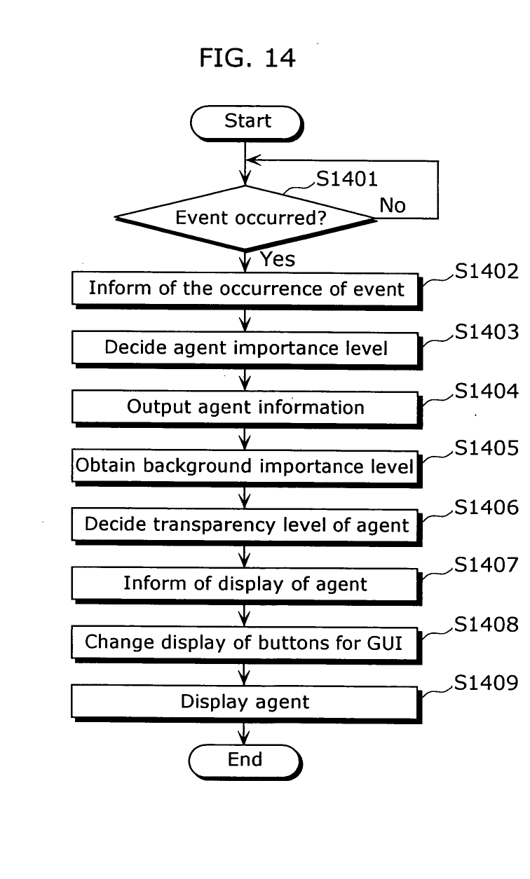

Firstly, the processing (1) will be described. FIG. 14 is a flowchart showing the flow of processing to be operated until the agent information is displayed on the screen.

It should be noted that an event of receiving an e-mail is taken as an example of an event of displaying a message for the user.

When an event of receiving an e-mail occurs (Yes in S1401), the e-mail reception unit 191 stores the received e-mail in the personal information storage unit 193, and informs the event management unit 192 of the reception of the e-mail by sending an identifier of the e-mail (S1402). Thus, the event management unit 192 reads out, from the personal information storage unit 193, the information related to the e-mail that corresponds to the identifier received from the e-mail reception unit 191, and determines the agent importance level based on the readout information related to the e-mail (S1403).

The event management unit 192 then outputs the agent importance level to the agent importance level setting unit 120, and at the same time, outputs the agent information to be displayed to the agent information setting unit 110 (S1404). FIG. 5 shows an example of the agent information. Note that the letter string whose attribute value is “An e-mail is received from ◯◯.” is created according to the sender of the e-mail. For example, the letter string “◯◯” may be replaced by the e-mail address “taro@abc.com”, namely the letter string may be changed using the chart indicating the correspondence between e-mail addresses and names as shown in FIG. 11. As far as the communication terminal 300 such as a cell phone is concerned, the management of the information indicating a correspondence between an e-mail address and a letter string presenting a name is a technique which has generally been acknowledged.

The display status decision unit 150 obtains a background importance level from the background importance level management unit 130 (S1405) as well as an agent importance level from the agent importance level setting unit 120. The display status decision unit 150 then determines the transparency level of the agent information with the use of the information indicating the correspondence as shown in FIG. 10, and outputs it to the drawing data generation unit 160. The display status decision unit 150 informs the user interface management unit 140 that the agent information is displayed on the screen (S1407).

In this way, the user interface management unit 140 establishes a user interface for agent information use by changing the display of the buttons displayed on the screen so as to adapt to the specification of the screen which displays the agent information (namely, the screen displayed in <agent information display mode> to be mentioned later on) (S1408).

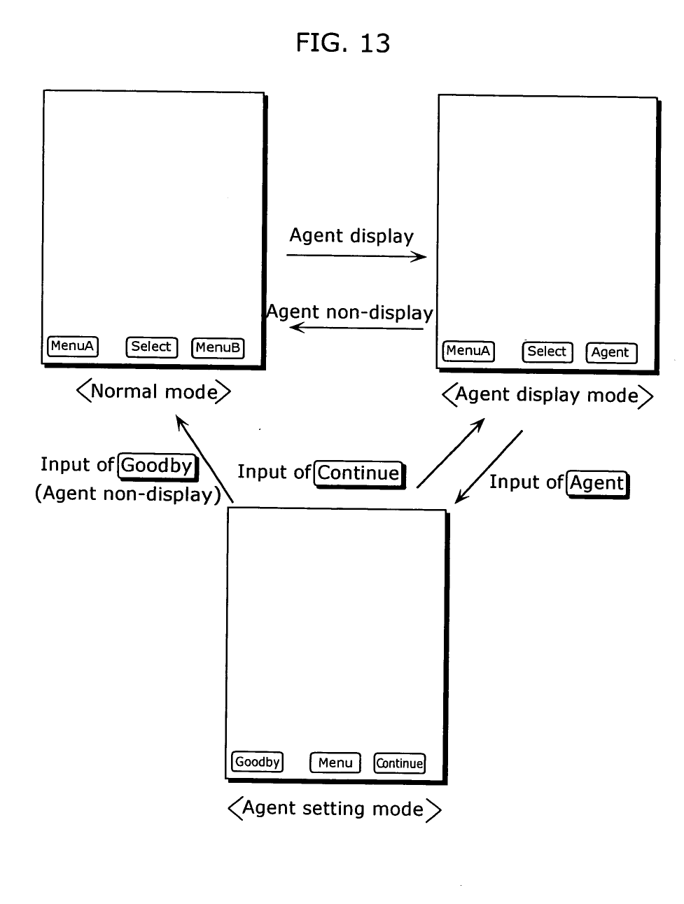

FIG. 13 shows how the screen display changes in displaying the agent information, which is managed by the agent interface management unit 140. The diagram shows, in particular, how the screen is displayed with the focus on the display of the buttons. When the agent information is displayed, the user interface management unit 140 changes the GUI screen from <normal mode> to <agent display mode>.

Then, the drawing data generation unit 160 receives respectively the agent information from the agent information setting unit 110 and the transparency level of the agent information from the display status decision unit 150, and generates the drawing data necessary for the display of the agent information. Lastly, the drawing data generated by the drawing data generation unit 160 is sent to the agent drawing unit 180. The agent drawing unit 180 displays an image including the agent information on the display unit 210 based on the received drawing data (S1409).

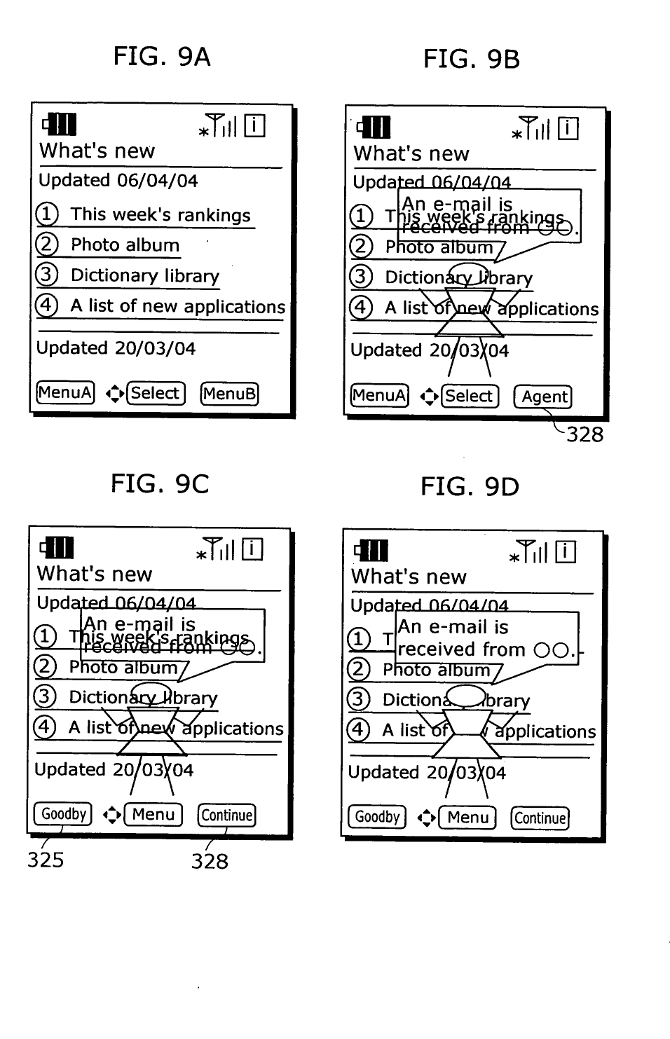

FIGS. 9A and 9B show how the screen display changes according to the processing (1). FIG. 9A shows the screen before the processing (1) is operated while FIG. 9B shows the screen after the processing (1) is operated. In FIG. 9B, a humanoid character and a speech balloon are displayed half-transparent as an example of the display of the agent information. The right menu display 328 for user interface use changes from the button “Menu B” to the button “Agent”. It should be noted that for the detail of the menu for agent information will be mentioned below in the processing (2).

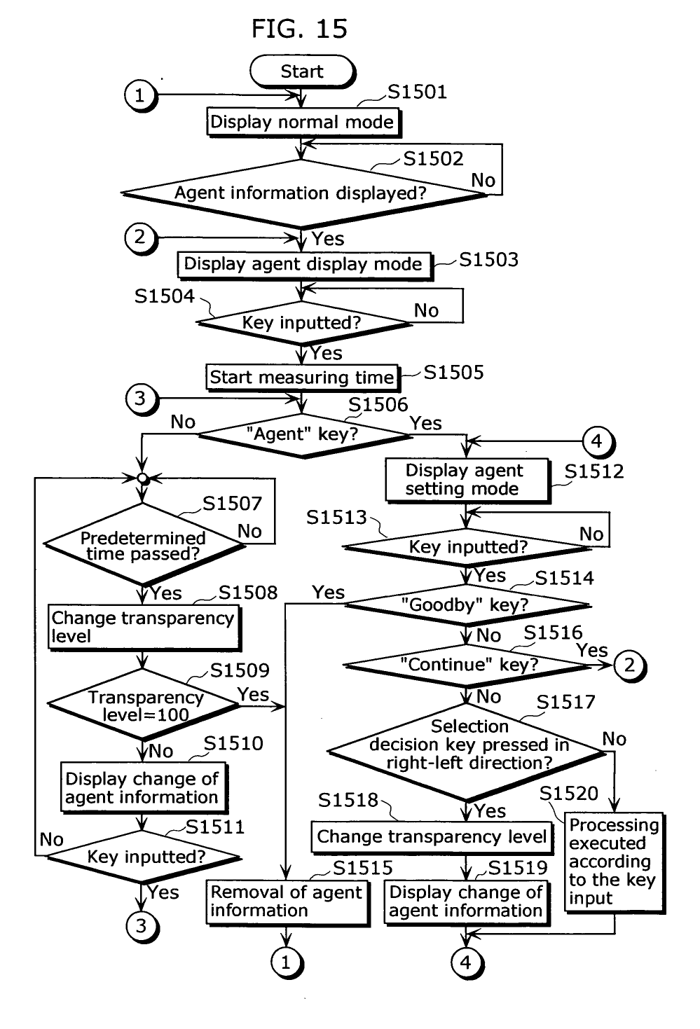

The following describes the processing (2) to be operated until the agent information displayed is removed from the screen, with reference to FIG. 15. It should be noted that, the processing (2) is to be executed after the processing (1) is terminated. FIG. 9B shows the screen display at the time of starting the processing (2).

With the communication terminal that can display the agent information, in general, an application can be used continuously even in the state of displaying the screen as shown in FIG. 9B. That is to say, even in the state in which the agent information is displayed on the screen, the user can continue working without interrupting the application. It is, however, preferable that the display of the agent information disappears when it is no longer necessary (e.g., when the user has read the agent information). The present agent display device 10 therefore enables the user to select the way of displaying the agent information, and furthermore, has a function to remove the agent information automatically in the case where a predetermined period of time has passed. Note that the agent information disappears automatically only in the case where the user operates the key input to the application being displayed on the screen (i.e., it is judged that the user has acknowledged the agent information, in the case where the key input is received from the user). Thus, it prevents the removal of the agent information without user's acknowledgment. The agent information shall disappear automatically but not suddenly by gradually increasing the transparency level of the agent information. Thus the user can perceive that the agent information is disappearing automatically, and perform an input operation so that the information does not disappear, in the case when the user desires to keep the information on the screen.

First, the user interface management unit 140 receives the notification that the agent information is displayed (Yes in S1502) on the screen displayed in normal mode (S1501), and displays the agent information (S1503). The user interface management unit 140 further receives a key input from the user (Yes in S1504), and starts measuring time, performed by the timer (S1505).

Next, in the case where the key input is not “Agent” (No in S1506), the user interface management unit 140 notifies the display status decision unit 150 that a predetermined period of time (e.g., two seconds) has passed at the predetermined time interval (Yes in S1507). Thus, the display status decision unit 150 changes the transparency level of the agent information by a predetermined portion (e.g., ten points), and notifies the drawing data generation unit of the change (S1508). The drawing data generation unit 160 then examines the value of the notified transparency level, and removes the agent information (S1515) in the case where the value indicates “100” (Yes in S1509) so as to shift to the display in normal mode (S1501). In the case where the value of the notified transparency level is less than “100” (No in S1509), the drawing data generation unit 160 continues to display the agent information with the modified transparency level (S1510).

Next, the processing of changing the display status of the agent information based on the user's instruction is explained with reference to FIGS. 2 and 9. The user interface management unit 140 receives the key “Agent” inputted by the user when the screen is displayed in <agent display mode> as shown in FIG. 9B (Yes in S1506), and displays the screen in <agent setting mode>as shown in FIG. 9C (S1512). After having received the notification of the key “Goodby” inputted via the key input unit 200, the user interface management unit 140 notifies the display status decision unit 150 of it. Thus, the display status decision unit 150 instructs the drawing data generation unit 160 to remove the agent information (S1515) and controls the display so that the screen shifts to the screen displayed in <normal mode> as shown in FIG. 9A (S1501). In the case where the key “Continue” is inputted from the user interface management unit 140, the display status decision unit 150 shifts the screen to the screen displayed in <agent display mode> as shown in FIG. 9B and controls the display so that the display of the agent information continues. It should be noted that in the case where the notification of the key input of “left or right of the selection decision key is pressed” is received from the user interface management unit 140, the display status decision unit 150 changes the transparency level of the agent information by a predetermined portion (e.g., the transparency level is reduced by ten points in the case where the left part of the selection decision key is pressed while the transparency level is increased by ten points in the case where the right part of the key is pressed) (S1518) and controls to display the agent information with the modified transparency level (S1519).

In the case where the notification of the key input other than those mentioned above is received from the user interface management unit 140, the display status decision unit 150 controls the screen display so that the processing is performed according to the key input (S1520).

It should be noted that FIG. 9D shows a state in which the agent information is displayed completely in opaque, namely, the background is hidden by the agent information.

As described above, there are three methods for removing the agent information: removing automatically by measuring the time passed; inputting the key “Goodby”; and setting the transparency level of the agent information to “0” with the use of the direction key.

### Second Embodiment

The first embodiment described above has shown an embodiment for determining the transparency level of the agent information based on the background importance level and the agent importance level. The present embodiment, however, shows an embodiment of determining the transparency level of the agent information in view of a correlation between the background and a display status of the agent information.

It should be noted that the functional structure of the agent display device 20 (although not shown in the diagram) according to the present embodiment is basically the same as that of the agent display device 10 according to the first embodiment described above. However, the display status decision unit 250 (though not shown in the diagram) in the present agent display device 20 further includes a function to identify whether the background is in text display or in image display, and determines the transparency level according to the state of the background, in addition to the functions of the display status decision unit 150 in the agent display device 10. For example, the identification can be realized by defining beforehand that the screen for editing an e-mail is displayed in text display while the screen for reviewing a shot image is displayed in image display.

The display status decision unit 250 further has a function to control the display by displaying the image with lower importance level in black and white (or in sepia) based on the background importance level and the agent importance level.

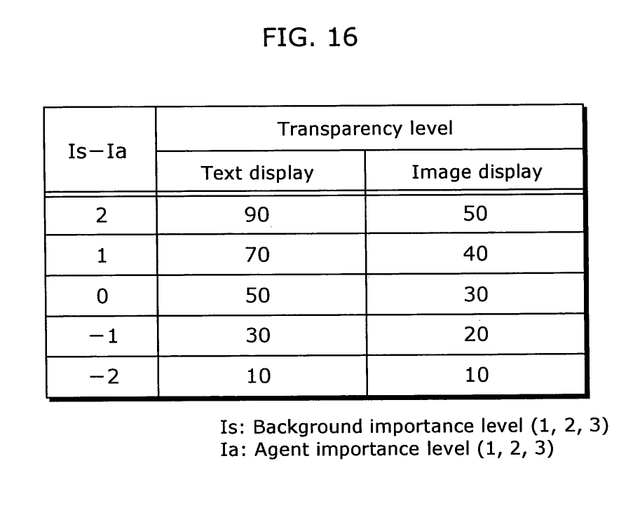

FIG. 16 shows an example of the chart presenting the relationship between the background importance level and the agent importance level, in the case where the display status of the background is taken into account. As shown in FIG. 16, the transparency level of the agent information differs between the case where the background is displayed in text display and the case where the background is displayed in image display. This enables the user to perceive the agent information even when the agent information with high transparency level is displayed on a simple screen such as the one in text display. However, in the case where the agent information is displayed with the same transparency level as that of the screen with complicated image as can be seen in a color image, the colors are mixed and it is difficult for the user to perceive the agent information. Therefore, in the case where the background is displayed in image display, the transparency level of the agent information is lower compared to the case where the background is displayed in text display.

The display status decision unit 250 displays the image with lower importance level in black and white based on the background importance level and the agent importance level. For the display in black and white, a luminance I may be calculated for color signals R, G, and B using the following equation:
I=(R+G+B)/3 (2)

The luminance I may be calculated with the use of YIQ conversion so that the luminance I for each of the signals is expressed as “R=G=B=I”, using the following equation:
I=0.2999*R+0.587*G+0.114*B (3)

It should be noted that for the display in sepia color, an offset α is added or removed as in “(R, G, B)=(I+α, |, |−α)”, in addition to the above processing, so that each of the values are set within a range of 0-255 (in the case of 8 bit expression).

It should be noted that the present invention is not limited to the display of the agent information for the cell phone and can be applied to the GUI and other various applications used in a PC environment.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

Industrial Applicability

The present invention can be applied to the communication terminal used in the computer environment, and particularly to a cell phone, a PDA, a car navigation system and a digital TV, each of which can display the agent information to be displayed in providing information useful for the user.

1. An agent display device for displaying a predetermined agent by superimposing the agent on a background, said device comprising:
a background display unit operable to display the background;
an agent specification unit operable to specify the agent to be displayed;
a transparency level determination unit operable to determine a transparency level in displaying the specified agent; and
an agent superimposition unit operable to display the agent with the determined transparency level by superimposing the agent on the background.

2. The agent display device according to claim 1,
wherein the agent is made up of three types of data: (i) data representing a character of the agent; (ii) data representing a speech balloon; and (iii) data representing service information to be provided for a user, and
the agent specification unit includes:
an event detection unit operable to detect an occurrence of an event and identify the event; and
a data specification unit operable to specify said three types of data: (i) the data representing the character; (ii) the data representing the speech balloon; and (iii) the data representing the service information, according to the identified event.

3. The agent display device according to claim 2,
wherein at least one of (i) the data representing the character, (ii) the data representing the speech balloon, and (iii) the data representing the service information is made up of three-dimensional shape data.

4. The agent display device according to claim 2,
wherein the agent specification unit further includes a storage unit operable to store, in association with said identified event, said three types of data: (i) the data representing the character; (ii) the data representing the speech balloon; and (iii) the data representing the service information, and
the data specification unit specifies each of said three types of data by reading out each of said data according to the identified event.

5. The agent display device according to claim 2,
wherein the transparency level determination unit includes:
a background importance level determination unit operable to determine a background importance level of the background based on the event;
an agent importance level determination unit operable to determine an agent importance level of the agent based on the event; and
a transparency level calculation unit operable to calculate the transparency level based on the background importance level and the agent importance level.

6. The agent display device according to claim 5,
wherein the transparency level determination unit further includes an importance level comparison unit operable to compare the determined background importance level with the determined agent importance level, and
the agent superimposition unit performs said superimposed display by changing a color of either the background or the agent, based on the comparison.

7. The agent display device according to claim 6,
wherein the change of color is made either into black and white or sepia color.

8. The agent display device according to claim 5 further comprising an instruction reception unit operable to receive an instruction from the user,
wherein the transparency level determination unit further changes the transparency level based on the instruction received from the user.

9. The agent display device according to claim 5,
wherein in the case where a screen is composed of a plurality of areas, the background importance level determination unit determines a background importance level for each of the plurality of areas.

10. The agent display device according to claim 5,
wherein the event is a reception of an e-mail.

11. The agent display device according to claim 10,
wherein the event detection unit further identifies a sender of the received e-mail, and
the agent importance level determination unit determines the agent importance level based on the sender.

12. The agent display device according to claim 10,
wherein the event detection unit further identifies a letter string included in a title of the received e-mail, and
the agent importance level determination unit determines the agent importance level based on the letter string included in the title.

13. The agent display device according to claim 1,
wherein the transparency level determination unit includes:
an input detection unit operable to detect a key input from a user; and
a time measurement unit operable to measure an elapsed time after the detection; and
a transparency level change unit operable to change the determined transparency level according to the elapsed time, and
the agent superimposition unit displays the agent with the changed transparency level by superimposing the agent on the background.

14. The agent display device according to claim 1,
wherein the transparency level determination unit further identifies the background as a screen either in text display or in image display, and determines the transparency level based on the identification.

15. An agent display method for displaying a predetermined agent by superimposing the agent on a background, said method comprising:
a background display step of displaying the background;
an agent specification step of specifying the agent to be displayed;
a transparency level determination step of determining transparency level in displaying the specified agent; and
an agent superimposition step of displaying the agent with the determined transparency level by superimposing the agent on the background.

16. A program for an agent display device for displaying a predetermined agent by superimposing the agent on a background, said program causing a computer to execute:
a background display step of displaying the background;
an agent specification step of specifying the agent to be displayed;
a transparency level determination step of determining a transparency level in displaying the specified agent; and
an agent superimposition step of displaying the agent with the determined transparency level by superimposing the agent on the background.
